(19) United States
(12) Patent Application Publication
(10) Pub. No.: US 2010/0026916 A1
(43) Pub. Date: Feb. 4, 2010

(54) ADJUSTABLE MONITOR HOOD

(76) Inventor: Huang-Pin Lin, Taipei County (TW)

Correspondence Address: NORTH AMERICA INTELLECTUAL PROPERTY CORPORATION, P.O. BOX 506, MERRIFIELD, VA, 22116, US

(21) Appl. No.: 12/233,595

(22) Filed: Sep. 19, 2008

(30) Foreign Application Priority Data
Jul. 31, 2008 (TW) 097128974

(51) Int. Cl. H04N 5/64

(52) U.S. Cl. 348/842; 348/E05.128

(57) ABSTRACT

The top plate of a monitor hood has at least a hooked slideway for guiding the left/right plates to slide along a direction in the top plate when mounting therein. When the monitor hood is required to be mounted on monitors with different size, the top plate is first fixed on the top plane of the monitor, then the left/right plates are slid outward or inward based on the width of the monitor such that the side components of each plate locate right on the left/right planes of the monitor and can be fixed thereon. The left/right plates are made of polypropylene and capable of being processed with V-shape grooves and bent out sections to be fixed on the monitor. The left/right plates are further made of detachable two-piece components and assembled with plastic rivets.

### BACKGROUND OF THE INVENTION

1. Field of the Invention

The present invention relates to monitor hood, and more specifically, to a monitor hood having left/right side plates capable of sliding relative to top plate via slideway for adjusting the width.

2. Description of the Prior Art

In order to reduce screen glare, shade from room or window lighting, and reduce eye fatigue, more and more flat panel or regular CRT monitors adopt a monitor hood around and therefore have more delicate, vivid, and precise color output. On the other hand, color calibration for a monitor by using a color calibration device is, for many professionals, a common method to ensure that the color presented on the screen of the monitor is consistent with the requirement for printed output. In such case, the monitor hood can effectively shield environmental lights and provide the color calibration device a perfect place to obtain correct color information from the screen.

For monitors at the market having various sizes, monitor hoods that fit to the monitor should have corresponding width as well such that a left side plate and a right side plate of the monitor hood mount right on the left side plane and the right side plane of the monitor. Conventional monitor hoods assemble each component, a top plate, a right side plate, and a side left plate, by using screws and then surround and fix on the monitor with screws. Such monitor hood according to the prior art, however, can only be used for monitors with one size. For monitors with a different size, they should use another monitor hoods that can fit exactly the dimension of the monitors.

On the other hand, there is also monitor hood in the market that can fit to monitors with some different sizes. Certain installing slots at the top plate that correspond to monitors with different sizes should be prepared in advance so that the right side plate and the left side plate and the top plate form the monitor hood that has corresponding width when the side plates are mounted on the top plate. With the size of the monitor changes rapidly, however, there is even more delicate classification of sizes for monitors classified to the same size. The pre-designed adjustable monitor hood therefore has its limitation to meet the requirement for that many different sizes.

Additionally, conventional plastic monitor hood must consider its material that is quite thick and for those molded plates, large-size finished goods may deform even more violently, with poor smoothness. Greater tolerance is a must when assembling two components. This lowers overall precision when mounting the monitor hood on the monitor and if the monitor hood can not closely match the surface of the monitor, leakage of lights can be a problem. The large-size left/right side plates also take up quite a lot space of package and this will raise the cost.

### SUMMARY OF THE INVENTION

The present invention provides a width-adjustable monitor hood, which is mounted on a monitor. The monitor comprises a top plane, a first side plane, and a second side plane. The monitor hood comprises a first side plate mounted on the first side plane of the monitor and comprising a first top component and a first side component, a second side plate mounted on the second side plane of the monitor and comprising a second top component and a second side component, and a top plate mounted on the top plane and having at least a slideway. The first top component and the second top component are mounted at two sides of the top plate respectively and are capable of sliding along a first direction on the slideway for having adjustable distance between the first side component and the second side component.

The present invention also provides a width-adjustable monitor hood, which is mounted on a monitor. The monitor comprises a top plane, a first side plane, and second side plane. The monitor hood comprises a side plate mounted on the first side plane of the monitor and comprising a top component and a first side component, and a main plate mounted on the top plane and comprising a top plate and a second side component. The second side component is mounted on the second side plane of the monitor. The top plate has at least a slideway and the top component is mounted at a first side of the top plate and is capable of sliding along a first direction on the slideway for having adjustable distance between the first side component and the second side component.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an illustration of a monitor hood mounted on a monitor.

FIG. 2 is an illustration of the width-adjustable monitor hood.

FIG. 3 is an illustration of a front view of the monitor hood in FIG. 2.

FIG. 4 is an illustration of a top view of the monitor hood in FIG. 2.

FIG. 5 is an illustration of the top plate of the monitor hood.

FIG. 6 is an illustration of the left side plate.

FIG. 7 is an illustration of the right side plate.

FIG. 8 is an illustration of the side plate slidably mounted at the top plate.

FIG. 9 is an illustration showing bending process of each plate of the monitor hood.

FIG. 10 is a partial cross-section view of the left side plate of the monitor hood.

FIG. 11 is an illustration of the side plates assembled with Velcro.

FIG. 12 is an illustration of the side plates assembled with buttons.

### DETAILED DESCRIPTION

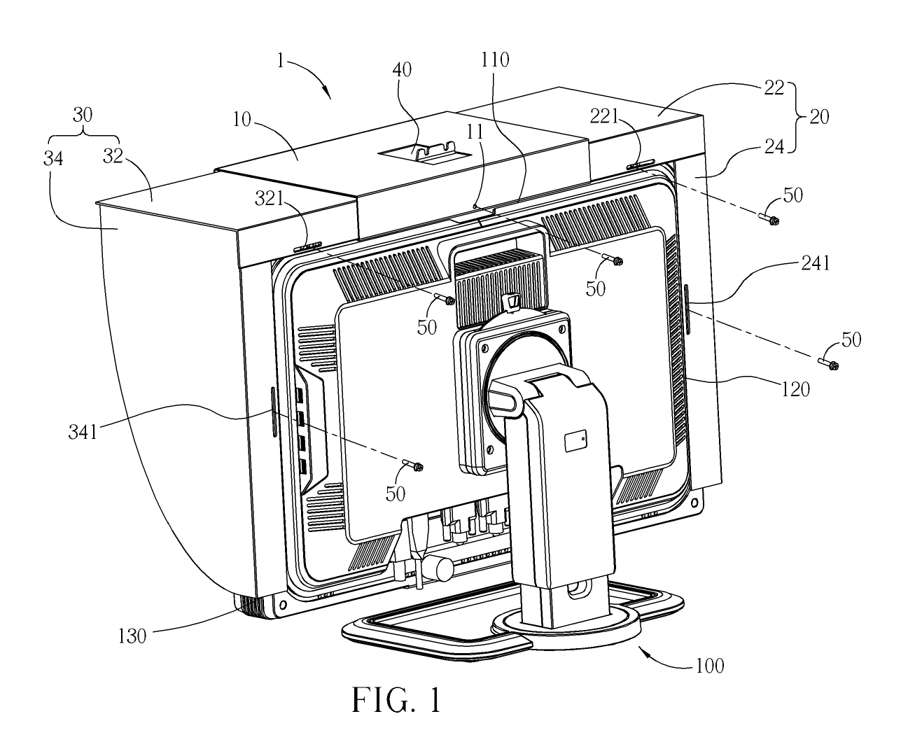

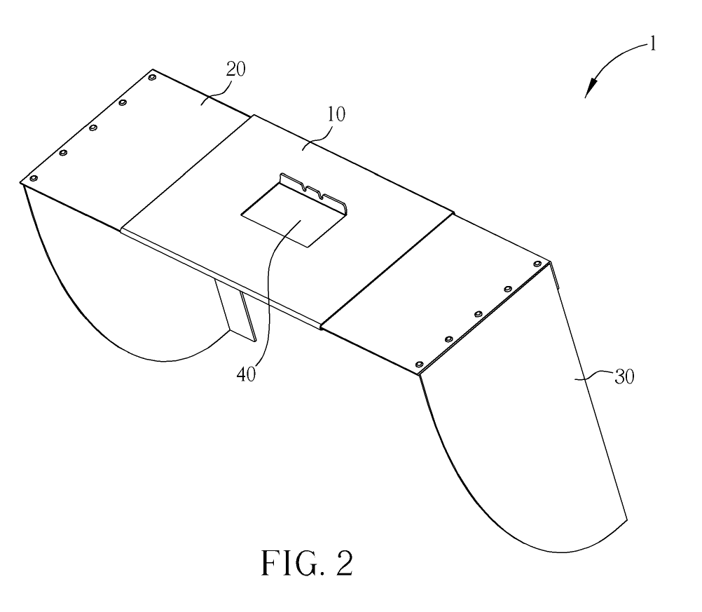

Please refer to FIG. 1 and FIG. 2. FIG. 1 is an illustration of a monitor hood 1 mounted on a monitor 100 according to the present invention and FIG. 2 is an illustration of the width-adjustable monitor hood 1. The monitor hood 1 includes a top plate 10, a left side plate 20, and a right side plate 30. A movable door 40 that can be opened or closed is configured at the top plate 10 for allowing a color calibration device to pass through. The left side plate 20 includes a left top component 22 and a left side component 24 and the right side plate 30 includes a right top component 32 and a right side component 34. The monitor 100 includes a top plane 110, a left side plane 120, a right side plane 130, and a screen plane that is not shown in the figure. The monitor hood 1 is mounted on the monitor 100 by using hand-operating screws 50 screwing into installing slots 11,221,241,321,341 on the plates so that the top plate 10 is mounted on the top plane 110, the left side plate 20 is mounted on the left side plane 120, and the right side plate 30 is mounted on the right side plane 130, forming an enclosure structure that can effectively shield lights from above, left, and right of the monitor 100 so that the screen can be much more delicate, vivid, and correct.

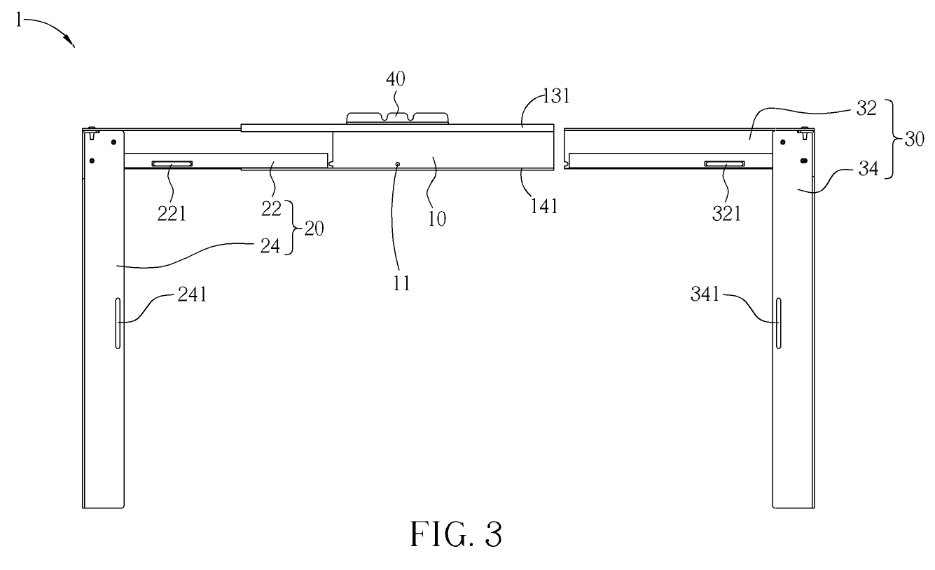

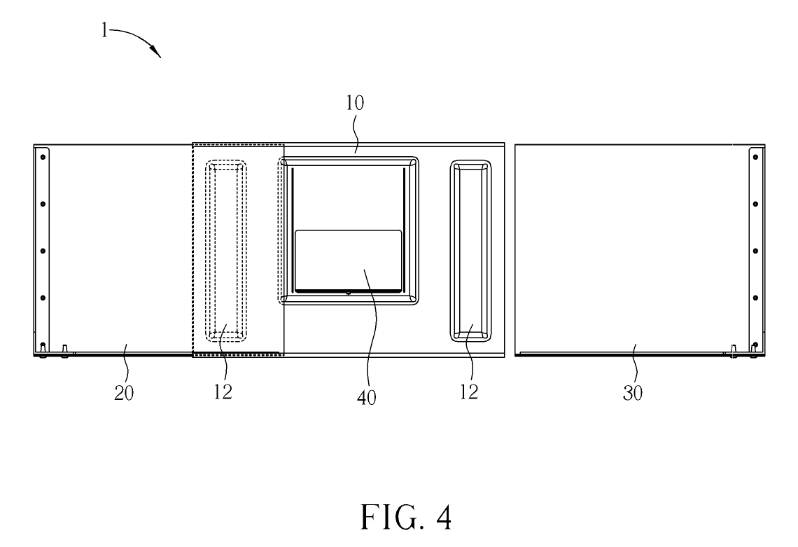

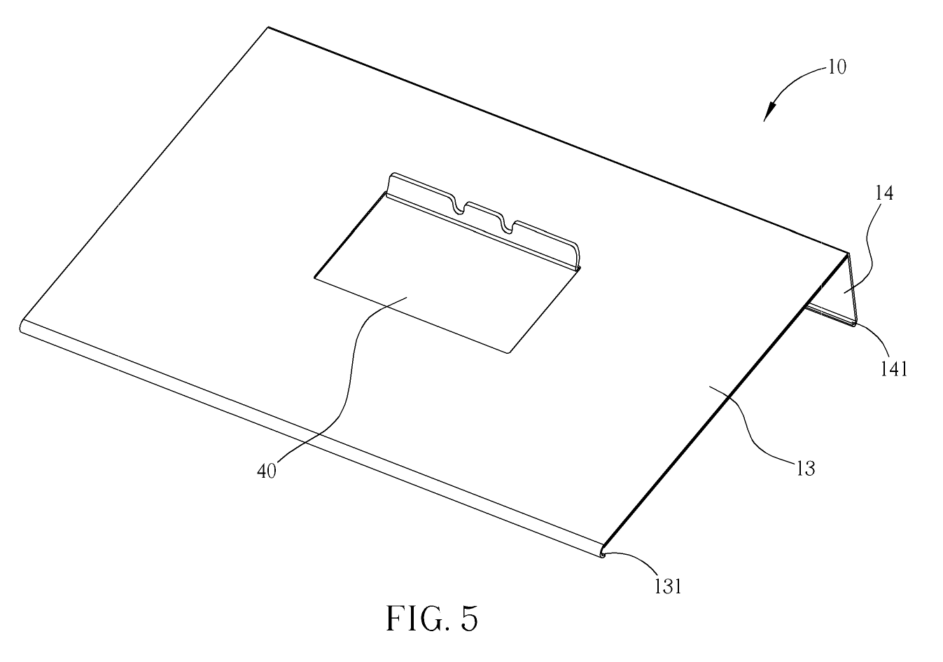

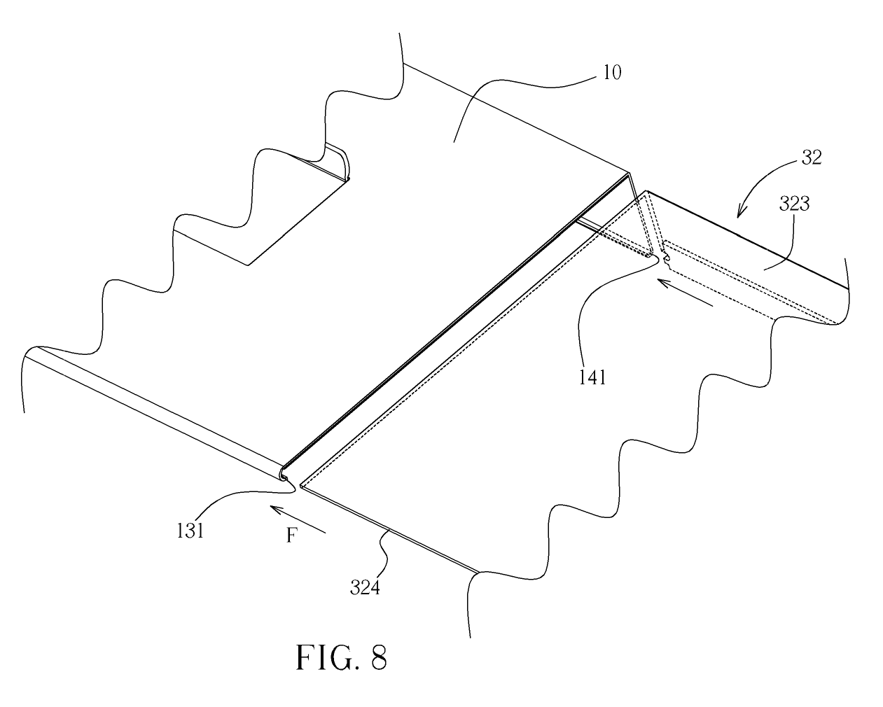

Please refer to FIG. 3, FIG. 5, and FIG. 8. FIG. 3 is an illustration of a front view of the monitor hood 1, FIG. 5 is an illustration of the top plate 10 of the monitor hood 1, and FIG. 8 is an illustration of the right side plate 30 slidably mounted at the top plate 10. The left side plate 20 and the right side plate 30 of the monitor hood 1 in the present invention mount at two sides of the top plate 10 detachably and are capable of sliding relative to the top plate 10 so that the left side plate 20 and the right side plate 30 can have different distance to fix any monitor with different size. The top plate 10 includes a top section 13 and a mounting section 14. FIG. 8 shows that there are bending hooked slideways 131,141 at the ends of the top section 13 and the mounting section 14 respectively. The right top component 32 of the right side plate 30 is mounted at the top plate 10 along direction F, while the left top component 22 of the left side plate 20 is mounted at the top plate 10 along opposite direction of direction F. A front end 324 of the right top component 32 (and a front end 224 of the left top component 22) is inserted into the slideway 131 and an installing section 323 (and an installing section 223) is inserted into the slideway 141 such that the right side plate 30 (and the left side plate 20) can slide in the top plate 10 along direction F. Meanwhile, the top section 13 of the top plate 10 also includes two protrusions 12 configured at the surface that faces the left top component 22 and the right top component 32, which is shown in FIG. 4. When the left/right top components 22,32 slide along the slideways 131,141 in the top section 13, the protrusions 12 can be utilized to abut the left/right top components 22,32 and confine them to slide just along direction F, with much more smooth movement. The slidable left/right side plates 20,30 are therefore ready to be adjusted to proper positions and relative to the top plate 10 to match the size of the mounted monitor 100. Additionally, in another embodiment of the present invention, the monitor hood can be designed to have one side plate movable relative to the top plate, while the top plate includes a fixed other side plate at the opposite side. For example, the left side plate can slide relative to a main plate, which includes a top plate and a right side plate as a single component, and the monitor hood has similar function for adjusting the width of the monitor hood as the previous embodiment.

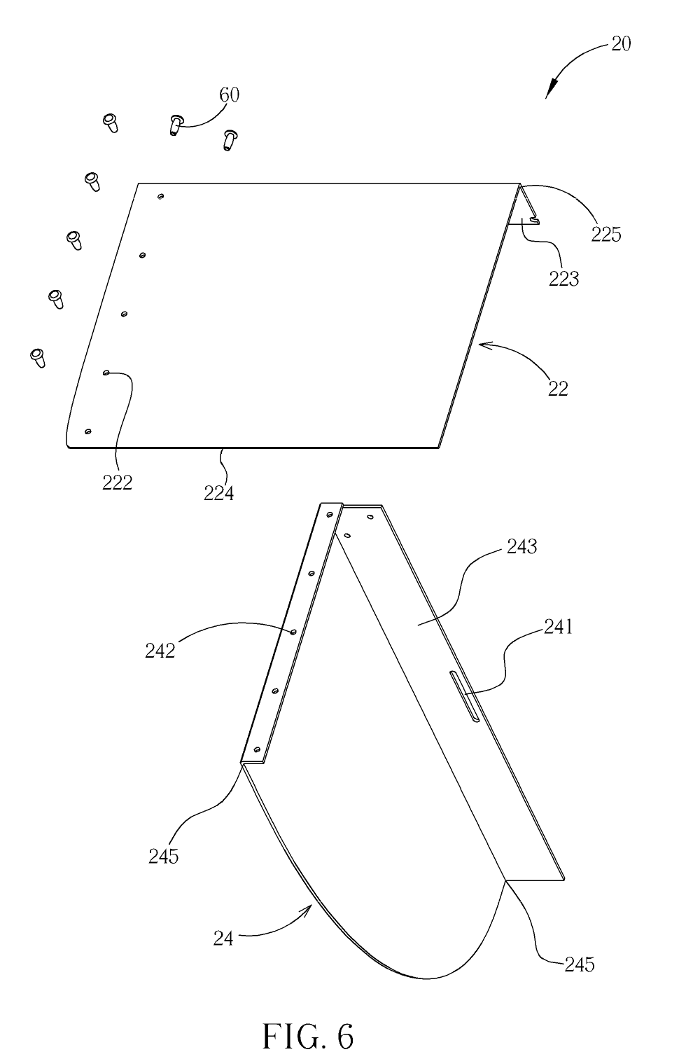

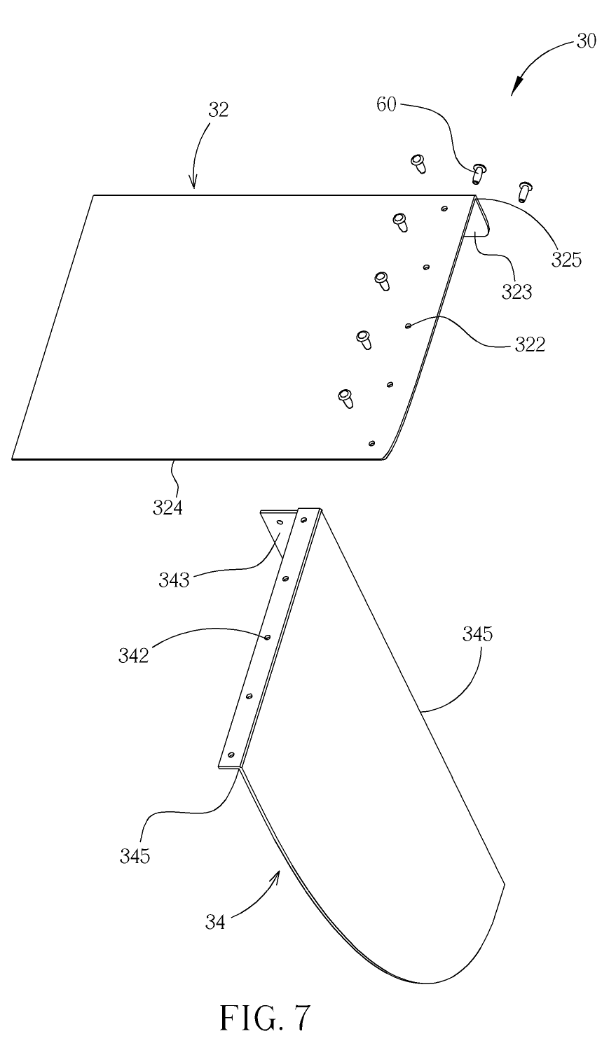

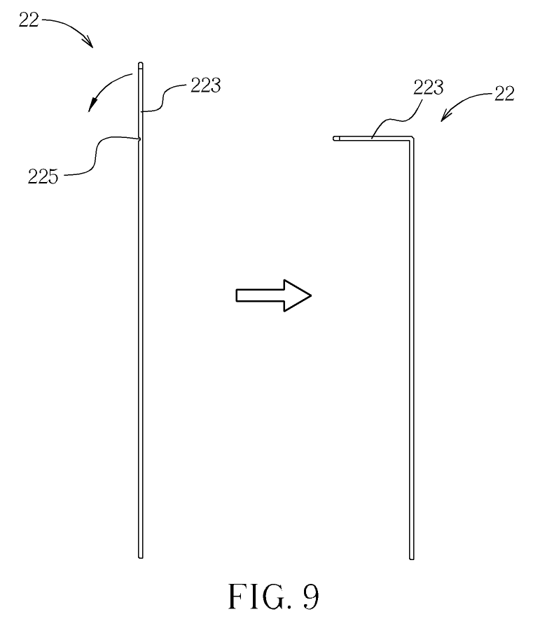

Please refer to FIG. 6, FIG. 7, and FIG. 9. FIG. 6 is an illustration of the left side plate 20 of the monitor hood 1, FIG. 7 is an illustration of the right side plate 30 of the monitor hood 1, and FIG. 9 is an illustration showing bending process of each plate of the monitor hood 1. For easier manufacturing for the monitor hood 1 and reducing the package size to save cost of package and transport before the monitor hood 1 is assembled to use, the left side plate 20 and the right side plate 30 can be made of polypropylene (PP) that has repeatedly-bending and fracturing-free features. After the PP plastic plate is cut to the shape of the left/right side plates 20,30, the left/right side plates 20,30 can be as larger and robust as possible, and their thickness can be reduced to 2 mm that saves material cost and size of the plates but still meets the manufacturing and mechanical strength requirement. As FIG. 9 shows, the left top component 22 at the left side of the figure is cut a V-shape groove 225 at a proper location, shown as in the left of FIG. 9, and produces the installing section 223 after bending along the V-shape groove 225 as shown at the right side of the figure. The installing section 223 is repeatedly bendable because of the property of the material. The left side plate 20 and the right side plate 30 in FIG. 6 and FIG. 7 produce each installing sections 223,243,323,343 by cutting out V-shape grooves 225,245,325,345 from the plane plate, and each side plate allows for much easier package and assembly.

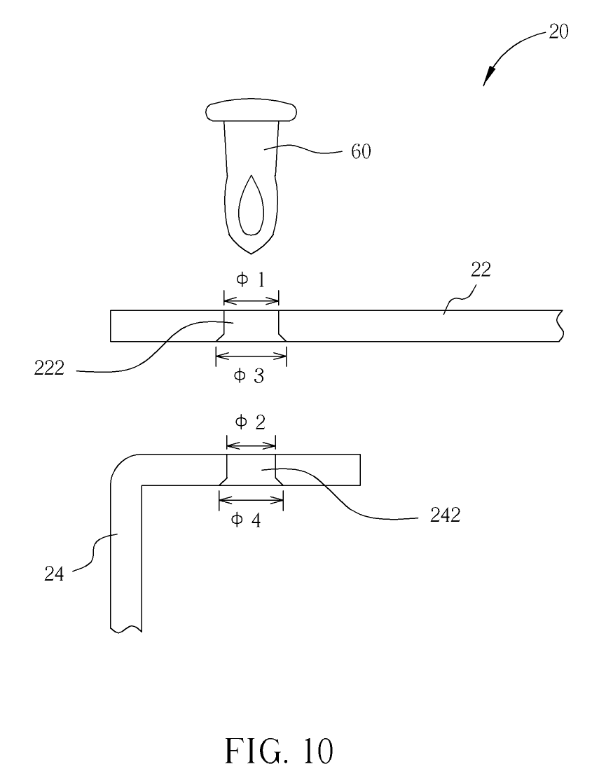

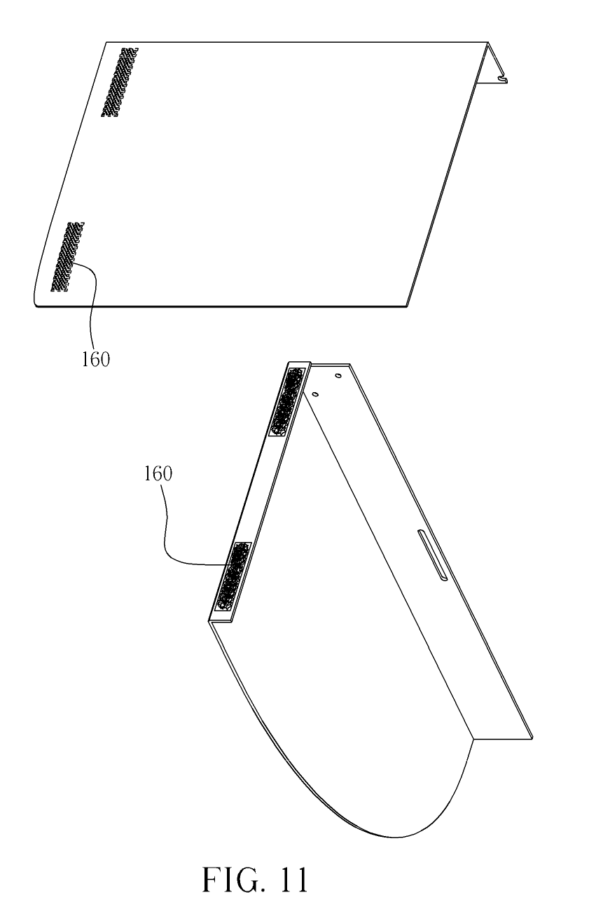

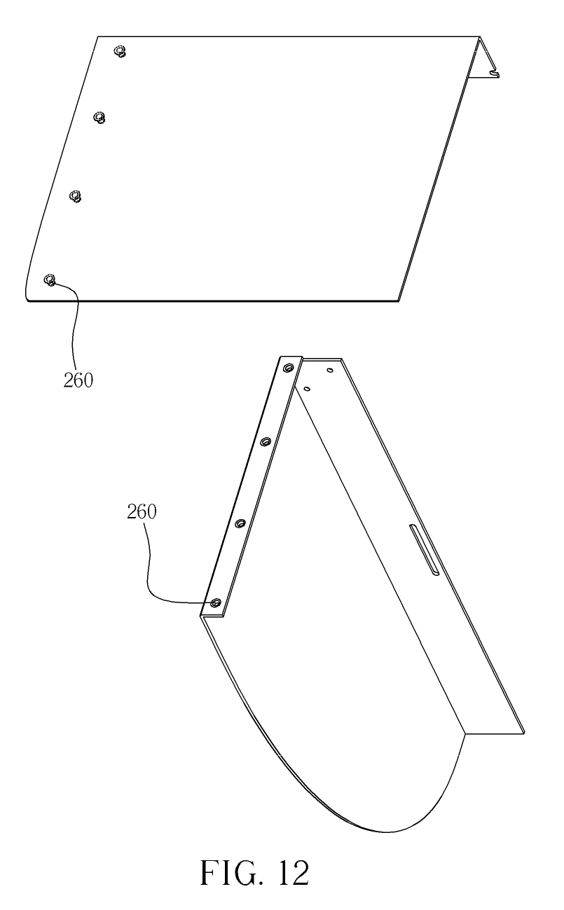

Additionally, the left side plate 20 and the right side plate 30 in the embodiment are two-piece detachable plates. The left top component 22 and the left side component 24 assemble together by passing each of the plurality of plastic rivets 60 through a first positioning hole 222 and a corresponding second positioning hole 242 respectively, and the right top component 32 and the right side component 34 assemble together by passing each of the plurality of plastic rivets 60 through a first positioning hole 322 and a corresponding second positioning hole 342 respectively. The plastic rivets 60 have the advantages of repeating and easy installation without the need of auxiliary tool. Please refer to FIG. 10, which is a partial cross-section view of the left side plate 20 of the monitor hood 1. In this embodiment, the first positioning hole 222 has a first aperture φ1 and the second positioning hole 242 has a second aperture φ2, while the first positioning hole 222 and the second positioning hole 242 have outer lead angle respectively, each with a third aperture φ3 and a fourth aperture φ4, and φ3 is larger than φ1, and φ4 is larger than φ2. Because of the relation between the apertures φ1, φ2, φ3, φ4, the first positioning hole 222 and the second positioning hole 242 are therefore characterized with 45° outward lead angle. In this embodiment, the first aperture φ1 of the first positioning hole 222 is even larger than the second aperture φ2 of the second positioning hole 242 such that the plastic rivets 60 installed in the first positioning hole 222 and the second positioning hole 242 can be easily detached because of the tilt angle of the lead angle. The corresponding description of the right side plate 30 is similar to the left side plate 20 and is omitted here for brevity. In addition to the plastic rivets 60, the left top component 22 and the left side component 24 (or the right top component 32 and the right side component 34) can also use other types of connectors for assembling. FIG. 11 shows that Velcro 160 is used to attach the two components and FIG. 12 shows that buttons 260 or other types of fasteners are used to attach the two components. Plastic rivets 60 in the previous embodiment should not be limitation of the way to assemble the components. It can be of more advantageous that connectors like Velcro 160 or the buttons 260 are fixed on the surfaces of the left top component 22 and the left side component 24 (and the right top component 32 and the right side component 34) and these connectors have no way of missing when disassembling or assembling the monitor hood 1. Additionally, the PP plastic left/right side plates 20,30 have certain degree of elasticity that allows for much easier way to repeatedly disassemble or assemble when using plastic rivets 60, Velcro 160, or the buttons 260 to fasten two components.

The monitor hood disclosed in the present invention is adjustable in width and has at least a hooked slideway at the top plate for guiding the left/right plates to slide along a direction in the top plate when mounting therein. When the monitor hood is required to be mounted on monitors with different size, the top plate is first fixed on the top plane of the monitor, then the left/right plates are slid outward or inward based on the width of the monitor such that the side components of each plate locate right on the left/right planes of the monitor and can be fixed thereon. The left/right plates are made of polypropylene and capable of being processed with V-shape grooves and bent out sections to be fixed on the monitor. The left/right plates are further made of detachable two-piece components and assembled with plastic rivets.

Those skilled in the art will readily observe that numerous modifications and alterations of the device and method may be made while retaining the teachings of the invention.

What is claimed is:

1. A width-adjustable monitor hood, mounted on a monitor, the monitor comprising a top plane, a first side plane, and a second side plane, the monitor hood comprising:
a first side plate mounted on the first side plane of the monitor and comprising a first top component and a first side component;
a second side plate mounted on the second side plane of the monitor and comprising a second top component and a second side component; and
a top plate mounted on the top plane having at least a slideway, the first top component and the second top component being mounted at two sides of the top plate respectively and capable of sliding along a first direction on the slideway for having adjustable distance between the first side component and the second side component.

2. The monitor hood of claim 1, wherein the slideway is a bending hooked slideway.

3. The monitor hood of claim 1, wherein the top plate further comprises protrusions at the surface facing the first top component and the second top component respectively, the protrusions being utilized for confining the first side plate and the second side plate to slide along the first direction when mounted at two sides of the top plate.

4. The monitor hood of claim 1, wherein the first top component of the first side plate and the second top component of the second side plate comprise a plurality of first positioning holes respectively, the first side component of the first side plate and the second side component of the second side plate comprise a plurality of second positioning holes corresponding to each first positioning hole respectively, the first top component and the first side component, the second top component and the second side component respectively assembled to each other detachably via a plurality of rivets, each rivet passing through a first positioning hole and a corresponding second positioning hole for assembling the first top component with the first side component and assembling the second top component with the second side component.

5. The monitor hood of claim 4, wherein the plurality of second positioning holes has outer lead angle respectively for providing tilt angle for detaching the rivet.

6. The monitor hood of claim 5, wherein the plurality of first positioning holes has outer lead angle outside the aperture, which is larger than the aperture of each second positioning hole.

7. The monitor hood of claim 1, wherein the first top component assembles with the first side component of the first side plate via at least a connector and the second top component assembles with the second side component of the second side plate via at least a connector.

8. The monitor hood of claim 7, wherein the connector is Velcro or a button.

9. The monitor hood of claim 1, wherein the first side plate and the second side plate are polypropylene (PP).

10. The monitor hood of claim 1, wherein each of the first top component and the first side component of the firs side plate, the second top component and the second side component of the second side plate, and the top plate has at least a V-shape groove such that the first side component and the second side component are bendable to have a mounting section for mounting on the first side plane and the second side plane respectively, and that the first top component, the second top component, and the top plate are bendable to have a mounting section for mounting on the top plane.

11. A width-adjustable monitor hood, mounted on a monitor, the monitor comprising a top plane, a first side plane, and second side plane, the monitor hood comprising:
a side plate mounted on the first side plane of the monitor and comprising a top component and a first side component; and
a main plate mounted on the top plane and comprising a top plate and a second side component, the second side component being mounted on the second side plane of the monitor, the top plate having at least a slideway, the top component being mounted at a first side of the top plate and capable of sliding along a first direction on the slideway for having adjustable distance between the first side component and the second side component.

12. The monitor hood of claim 11, wherein the slideway is a bending hooked slideway.

13. The monitor hood of claim 11, wherein the top plate further comprises a protrusion at the surface of the first side facing the first top component, the protrusion being utilized for confining the first side plate to slide along the first direction when mounted at the first side of the top plate.

14. The monitor hood of claim 11, wherein the top component of the side plate and the top plate of the main plate comprise a plurality of first positioning holes respectively, the first side component of the side plate and the second side component of the main plate comprise a plurality of second positioning holes corresponding to each first positioning hole respectively, the top component and the first side component, the top plate and the second side component respectively assembled to each other detachably via a plurality of rivets, each rivet passing through a first positioning hole and a corresponding second positioning hole for assembling the top component with the first side component and assembling the top plate with the second side component.

15. The monitor hood of claim 14, wherein the plurality of second positioning holes has outer lead angle respectively for providing tilt angle for detaching the rivet.

16. The monitor hood of claim 15, wherein the plurality of first positioning holes has outer lead angle outside the aperture, which is larger than the aperture of each second positioning hole.

17. The monitor hood of claim 11, wherein the top component assembles with the first side component of the side plate via at least a connector and the top plate assembles with the second side component of the main plate via at least a connector.

18. The monitor hood of claim 17, wherein the connector is Velcro or a button.

19. The monitor hood of claim 11, wherein the side plate is polypropylene (PP).

20. The monitor hood of claim 11, wherein each of the top component and the first side component of the side plate, and the top plate and the second side component of the main plate has at least a V-shape groove such that the first side component and the second side component are bendable to have a mounting section for mounting on the first side plane and the second side plane respectively, and that the top component and the top plate are bendable to have a mounting section for mounting on the top plane.
